(19) United States
(12) Patent Application Publication
(10) Pub. No.: US 2006/0128856 A1
(43) Pub. Date: Jun. 15, 2006

(54) Liquid curable resin composition

(75) Inventors: Atsuya Takahashi, Tokyo (JP); Junji Yoshizawa, Tokyo (JP); Masakatsu Ukon, Tokyo (JP); Zen Komiya, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: JRS Corporation, Tokyo (JP); JAPAN FINE COATINGS CO., LTD., Tokyo (JP); DSM IP ASSETS B.V., TE Heerlen (NL)

(21) Appl. No.: 10/529,180

(22) PCT Filed: Sep. 29, 2003
(86) PCT No.: PCT/JP03/12407

§ 371 Date: Jan. 10, 2006

(30) Foreign Application Priority Data
Sep. 30, 2002 (JP) 2002-285098

(51) Int. Cl. C08L 93/00

(52) U.S. Cl. 524/274

(57) ABSTRACT

Provided is a liquid curing resin composition exhibiting excellent adhesion to PET-PET, MS-PET and the like, having excellent processability, heat resistance and water resistance, and having a high-cure rate. A liquid curing resin composition containing the following components (A) and (B): (A) 30 to 70 wt. % of a urethane (meth)acrylate having a number-average molecular weight of from 10000 to 40000, and (B) 30 to 60 wt. % of an ethylenically unsaturated monomer having a glass transition point, in the form of a homopolymer, of 60° C. or greater.

### TECHNICAL FIELD

The present invention relates to a liquid curing resin composition, more specifically to a liquid curing resin composition useful as an adhesive in the fields of various building decorative materials, packaging materials, printing materials, display materials, materials for electrical and electronic components, materials for optical components, and liquid-crystal panels because of its excellent adhesion to glass, plastic substrates, and particularly to a styrene-(methyl methacrylate) copolymer (MS) or a polyethylene terephthalate (PET) film and its superiority in heat resistance, water resistance and moldability or formability.

### BACKGROUND ART

Liquid curing adhesives are in common use in various fields such as packaging materials, display materials such as label, electronic components, precision equipment and building materials. In recent years, liquid curing adhesives of an active energy ray curing type which is cured by ultraviolet light or electron beam are widely used instead of the conventional thermosetting adhesives in order to speed up production process and improve productivity. As application fields expand and the high demand for performance increases, there has been a great deal of demand for heightening the performance of liquid curing adhesives of an active energy ray curing type.

For example, a laminating adhesive for PET film is required to have high heat resistance as well as high adhesive force.

Physical properties required for those liquid curing adhesives are as follows:
(1) A liquid form at normal temperature and a high working efficiency.
(2) A high curing speed and good productivity.
(3) Adequate strength and flexibility.
(4) A small change in physical properties even by wide-ranging temperature variations.
(5) Excellent heat resistance.
(6) Excellent resistance against chemicals such as acid and alkali.
(7) Excellent water resistance.
(8) Excellent light fastness.
(9) Excellent oil resistance.
(10) High adhesion to a substrate (particularly high adhesion to MS, PVC, PET, polycarbonate and glass).

Meanwhile, a liquid curing adhesive composition containing (a) urethane (meth)acrylate having a small number-average molecular weight (5000 to 15000), (b) a compound selected from acryloylmorpholine, dimethylacrylamide, diethylacrylamide and diisopropylacrylamide, and (c) phenoxypolyethyleneglycol (PEG=1 to 5) acrylate has been reported to exhibit excellent adhesion to PVC or PET (Japanese Patent Application Laid-Open No. Hei 7-310067).

It has also been reported that a photocuring resin composition comprising (A) urethane (meth)acrylate, (B) a mercapto-containing silane compound, (C) a photopolymerization initiator, (D) an amino-containing ethylenically unsaturated monomer and (E) a (meth)acrylate compound is useful as a coating layer of a copper-clad wire used as a tension member of an optical fiber unit (Japanese Patent Application Laid-Open No. 2000-198824).

However, none of the above-described compositions have enough adhesive force, particularly to PET-PET and general-purpose MS-PET, nor is their heat resistance sufficient.

### DISCLOSURE OF THE INVENTION

An object of the present invention is therefore to provide a liquid curing resin composition exhibiting excellent adhesion for PET-PET, MS-PET and the like, excellent processability, heat resistance and water resistance, and a high cure rate.

The present inventors have carried out an extensive research in consideration of the actual conditions as described above. As a result, it has been found that the below-described composition containing, in combination, a urethane (meth)acrylate compound having a number-average molecular weight of from 10000 to 40000 and a large amount, more specifically, 30 to 60 wt. % of an ethylenically unsaturated monomer satisfies the above-described conditions, has excellent adhesion, heat resistance, water resistance and moldability or formability and is useful as an adhesive for various materials, particularly, a laminating adhesive for MS, PET film or the like, leading to the completion of the present invention.

The present invention therefore provide a liquid curing resin composition comprising the following components (A) and (B):

(A) 30 to 70 wt. % of a urethane (meth)acrylate compound having a number-average molecular weight of from 10000 to 40000, and

(B) 30 to 60 wt. % of an ethylenically unsaturated monomer having a glass transition point, in the form of its homopolymer, of 60° C. or greater.

### ADVANTAGES OF THE INVENTION

The liquid curing resin composition of the present invention exhibits excellent adhesion, is superior in heat resistance, water resistance, and moldability or formability, and is useful as an adhesive composition. It exhibits excellent adhesion to glass, plastic substrates, and especially, to MS plate or PET film so that it is suited for laminating an MS plate or PET film with a PVC sheet. In addition, it is also useful in various fields including building decorative materials, packaging materials, printing materials, display materials, materials for electrical or electronic components, materials for optical components and liquid-crystal panels.

### BEST MODE FOR CARRYING OUT THE INVENTION

The component (A) which can be used in the present invention is a urethane (meth)acrylate compound having a number-average molecular weight of from 10000 to 40000. The component (A) can be prepared by reacting a polyol compound, a polyisocyanate compound and a hydroxyl-containing (meth)acrylate compound.

More specifically, it is available by reacting an isocyanate group of a polyisocyanate compound, a hydroxy group of a polyol compound and a hydroxy group of a hydroxyl-containing (meth)acrylate compound. Following four processes can be mentioned as examples of the preparation process.
Preparation Process 1: a process of charging a polyol compound, a polyisocyanate compound and a hydroxyl-containing (meth)acrylate compound simultaneously to react them each other.
Preparation process 2: a process of reacting a polyol compound with a polyisocyanate compound and then reacting the reaction product with a hydroxyl-containing (meth)acrylate compound.
Preparation process 3: a process of reacting a polyisocyanate compound with a hydroxyl-containing (meth)acrylate compound, followed by reaction with a polyol compound.
Preparation process 4: a process of reacting a polyisocyanate compound with a hydroxyl-containing (meth)acrylate compound, reacting the resulting product with a polyol compound and then finally, reacting the reaction product with a hydroxyl-containing (meth)acrylate compound again.

Examples of the polyol which can be used as a raw material for the component (A) of the present invention include aromatic polyether polyols, aliphatic polyether polyols, alicyclic polyether polyols, polyester polyols, polycarbonate polyols and polycaprolactone polyols.

The aromatic polyether polyols include, for example, ethylene oxide added diols of bisphenol A, propylene oxide added diols of bisphenol A, butylene oxide added diols of bisphenol A, ethylene oxide added diols of bisphenol F, propylene oxide added diols of bisphenol F, propylene oxide added diols of bisphenol F, alkylene oxide added diols of hydroquinone and alkylene oxide added diols of naphthoquinone. Commercially available products of these aromatic polyether polyols are, for example, “Uniol”, DA700” and “DA1000” (each, product of NOF Corp.).

The aliphatic polyether polyols include those obtained by ring-opening (co)polymerization of at least one compound selected from ethylene oxide, propylene oxide, butylene oxide, tetrahydrofuran, 2-methyltetrahydrofuran, 3-methyltetrahydrofuran, substituted tetrahydrofuran, oxetane, substituted oxetane, tetrahydropyran and oxebane. Specific examples include polyethylene glycol, 1,2-polypropylene glycol, 1,3-polypropylene glycol, polytetramethylene glycol, 1,2-polybutylene glycol, polyisobutylene glycol, copolymer polyol between propylene oxide and tetrahydrofuran, copolymer polyol between ethylene oxide and tetrahydrofuran, copolymer polyol between ethylene oxide and propylene oxide, copolymer polyol between tetrahydrofuran and 3-methyltetrahydrofuran and copolymer polyol between ethylene oxide and 1,2-butylene oxide.

The alicyclic polyether polyols include ethylene oxide added diol of hydrogenated bisphenol A, propylene oxide added diol of hydrogenated bisphenol A, butylene oxide added diol of hydrogenated bisphenol A, ethylene oxide added diol of hydrogenated bisphenol F, propylene oxide added diol of hydrogenated bisphenol F, butylene oxide added diol of hydrogenated bisphenol F, dimethylol compounds of dicyclopentadiene and tricyclodecanedimethanol.

Examples of the commercially available products of these aliphatic polyether polyols and alicyclic polyether polyols include “UNISAFE DC1100”, “UNISAFE DC1800”, “UNISAFE DCB1100”, and “UNISAFE DCB1800” (each, product of NOF Corp.), “PPTG 4000”, “PPTG 2000”, “PPTG 1000”, “PTG 2000”, “PTG 3000”, “PTG 650”, “PTGL 2000”, and “PTGL 1000” (each, product of Hodogaya Chemical Co., Ltd.), “EXCENOL 4020”, “EXCENOL3020”, “EXCENOL2020” and “EXCENOL 1020” (each, product of Asahi Glass Co., Ltd.), “PBG 3000”, “PBG 2000”, “PBG1000” and “Z3001” (each, product of Daiichi Kogyo Seiyaku Co., Ltd.), “ACCLAIM 2200, 3201, 4200, 6300 and 8200” (each, product of Sumika Bayer Urethane Co., Ltd.); and “NPML-2002, 3002, 4002 and 8002” (each, product of Asahi Glass Co., Ltd.).

The polyester polyols include, for example, those available by reacting a polyhydric alcohol such as ethylene glycol, polyethylene glycol, propylene glycol, polypropylene glycol, tetramethylene glycol, polytetramethylene glycol, 1,6-hexanediol, neopentyl glycol, 1,4-cyclohexanedimethanol, 3-methyl-1,5-pentanediol, 1,9-nonanediol, or 2-methyl-1,8-octanediol with a polybasic acid such as phthalic acid, isophthalic acid, terephthalic acid, maleic acid, fumaric acid, adipic acid or cebasic acid. As their commercially available products, “Kurapol P2010”, “PMIPA”, “PKA-A”, “PKA-A2”, and “PNA-2000” (each, product of Kuraray Co., Ltd.) are available.

The polycarbonate polyols include, for example, 1,6-hexane polycarbonate and examples of the commercially available products include “DN-980, DN-981, 982, and 983 (each, product of Nippon Polyurethane Industry Co., Ltd.), and “PLACCEL CD-205, CD-983, CD-220” (each, product of Daicel Chemical Industries, Ltd.), and “PC-8000” (trade name; product of PPG/USA).

The polycaprolactone polyols include pplycaprolactone diols obtained by the reaction of E-caprolactone with a divalent diol such as ethylene glycol, polyethylene glycol, propylene glycol, polypropylene glycol, tetramethylene glycol, polytetramethylene glycol, 1,2-polybutylene glycol, 1,6-hexanediol, neopentyl glycol, 1,4-cyclohexanedimethanol, or 1,4-butanediol. Examples of their commercially available products include “PLACCCEL 205, 205AL, 212, 212AL, 220, 220AL” (each, product of Daicel Chemical Industries, Ltd.).

Examples of other polyols which can be used in the present invention include ethylene glycol, propylene glycol, 1,4-butanediol, 1,5-pentanediol, 1,6-hexanediol, neopentyl glycol, 1,4-cyclohexanedimethanol, polyβ-methyl-δ-valerolactone, hydroxyl-terminated polybutadiene, hydroxyl-terminal hydrogenated polybutadiene, castor oil modified polyol, terminated diol compounds of polydimethylsiloxane and polydimethylsiloxane carbitol modified polyol.

Of the above-described polyol compounds, polypropylene glycol, ethylene oxide/propylene oxide copolymer diol, ethylene oxide/1,2-butylene oxide copolymer diol, and propylene oxide/tetrahydrofuran copolymer diol are more preferred, with ethylene oxide/1,2-butylene oxide copolymer diol being particularly preferred.

The number-average molecular weight of the polyol compound to be used in the present invention is preferably from 500 to 12000, more preferably from 1500 to 9000, most preferably from 3500 to 9000. When the number-average molecular weight of the polyol compound is less than 500, a Young's modulus of the cured product at normal and low temperatures increases, sufficient adhesion cannot be achieved, and zipping occurs. On the other hand, the number-average molecular weight exceeding 12000 causes an increase in the viscosity of the composition, leading to deterioration in the coatability upon covering a substrate with the composition. The number-average molecular weight outside the above-described range is therefore not preferred.

Examples of the hydroxyl-containing (meth)acrylate compound which is one of the raw materials of the component (A) include 2-hydroxyethyl (meth)acrylate, 2-hydroxypropyl (meth)acrylate, 2-hydroxybutyl (meth)acrylate, 2-hydroxy-3-phenyloxypropyl (meth)acrylate, 1,4-butanediol mono(meth)acrylate, 2-hydroxyalkyl(meth)acryloyl phosphate, 4-hydroxycyclohexyl (meth)acrylate, 1,6-hexanediol mono(meth)acrylate, neopentylglycol mono(meth)acrylate, trimethylolpropane di(meth)acrylate, trimethylolethane di(meth)acrylate, pentaerythritol tri(meth)acrylate, dipentaerythritol penta(meth)acrylate, and (meth)acrylates represented by the following formula (1) or (2), 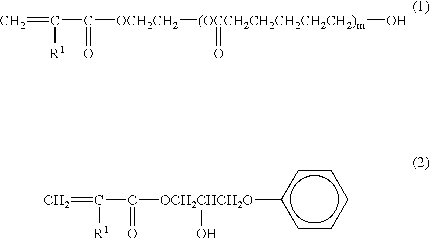
(in the formula (1) or (2), R¹ represents a hydrogen atom or a methyl group and m stands for 1 to 15). In addition, compounds obtained by the addition reaction between a glycidyl-containing compound such as alkyl glycidyl ether, allyl glycidyl ether, or glycidyl (meth)acrylate, and (meth)acrylic acid can also be used. Of these hydroxyl-containing (meth)acrylate compounds, 2-hydroxyethyl (meth)acrylate and 2-hydroxypropyl (meth)acrylate are especially preferred.

Examples of the polyisocyanate compound include 2,4-tolylene diisocyanate, 2,6-tolylene diisocyanate, 1,3-xylylene diisocyanate, 1,4-xylylene diisocyanate, 1,5-naphthalene diisocyanate, m-phenylene diisocyanate, p-phenylene diisocyanate, 3,3′-dimethyl-4,4′-diphenylmethane diisocyanate, 4,4′-diphenylmethane diisocyanate, 3,3′-dimethylphenylene diisocyanate, 4,4′-biphenylene diisocyanate, 1,6-hexane diisocyanate, isophorone diisocyanate, methylenebis(4-cyclohexyl isocyanate), 2,2,4-trimethylhexamethylene diisocyanate, 1,4-hexamethylene diisocyanate, bis(2-isocyanatoethyl)fumarate, 6-isopropyl-1,3-phenyl diisocyanate, 4-diphenylpropane diisocyanate, lysine diisocyanate, hydrogenated diphenylmethane diisocyanate, hydrogenated xylylene diisocyanate, and tetramethylxylylene diisocyanate. Of these, hydrogenated xylylene diisocyanate, isophorone diisocyanate, and 2,2,4-trimethylhexamethylene diisocyanate are preferred. These polyisocyanate compounds may be used either singly or in combination.

The urethane (meth)acrylate compound thus obtained as the component (A) of the present invention has a number-average molecular weight of from 10000 to 40000. When the number-average molecular weight of the urethane (meth)acrylate compound is less than 10000, desired adhesion cannot be achieved. The number-average molecular weight of the urethane (meth)acrylate compound exceeding 40000 causes an excessive increase in the viscosity of the composition. The number-average molecular weight outside the above-described range is therefore not preferred.

It is preferred to incorporate the urethane (meth)acrylate compound serving as the component (A) of the present invention in an amount of from 30 to 70 wt. %, especially from 45 to 70 wt. % in the composition of the present invention from the viewpoints of the coatability of the composition, adhesion characteristics of the adhesive after curing, processability, flexibility and long-term reliability.

The component (B) which can be used in the present invention is an ethylenically unsaturated monomer having a glass transition point, in the form of its homopolymer, of 60° C. or greater. Specific examples of the component (B) include acryloylmorpholine, dimethylacrylamide, diethylacrylamide, diisopropylacrylamide, isobornyl (meth)acrylate, dicyclopentenyl acrylate, dicyclopentanyl (meth)acrylate, dicyclopentenyloxyethyl (meth)acrylate, methyl (meth)acrylate, ethyl (meth)acrylate, cyclohexyl methacrylate, dicyclopentadientyl (meth)acrylate, tricyclodecanyl (meth)crylate, diacetone acrylamide, isobutoxymethyl (meth)acrylamide, N-vinylpyrrolidone, N-vinylcaprolactam, 3-hydroxycyclohexyl acrylate, and 2-acryloyl cyclohexylsuccinic acid. Of these, acryloylmorpholine, dimethylacrylamide, N-vinylpyrrolidone and N-vinylcaprolactam are preferred. As the component (B), the above-described compounds may be used either singly or in combination.

Of the above-described compounds as the component (B), isobornyl acrylate, dicyclopentenyl acrylate, dicyclopentanyl acrylate and dicyclopentanyloxyethyl acrylate have an advantage of improving the water resistance of the cured product of the present invention, while N-vinylpyrrolidone and N-vinylcaprolactam have an advantage of improving the curability of the composition of the present invention. Incorporation of two or more of these compounds as the components (B) as needed can impart the composition with more preferable physical properties. Combinations of at least one compound selected from acryloylmorpholine, dimethyl acrylamide, N-vinylpyrrolidone and N-vinylcaprolactam with at least one compound selected from isobornyl acrylate, dicyclopentenyl acrylate, dicylopentanyl acrylate and dicyclopentanyloxyethyl acrylate are particularly preferred.

Examples of the commercially available product of the component (B) include “ACMO”, “DMAA” (each, product of KOHJIN Co., Ltd.), “New Frontier IBA” (product of DAI-ICHI KOGYO SEIYAKU CO., LTD.), “IBXA” (product of OSAKA ORGANIC CHEMICAL INDUSTRY LTD.), “FAS11A, “FA512A”, and “FA513A” (each, product of Hitachi Chemical Co., Ltd.), “LIGHT-ESTER M, E, CH, TB, IB-X, and IB-XA” (each, product of KYOEISHA CHEMICAL Co., LTD), “ARONIX M150, M156, T01315 and T01316” (each, product of Toagosei Limited), and “FA544A, 512M, 512MT and 513M” (each, product of Hitachi Chemical Co., Ltd.)

The component (B) must be added in an amount of from 30 to 60 wt. % in the composition, with a range of from 40 to 60 wt. % being especially preferred. It is not always possible to obtain desired adhesive force when the amount of component (B) is less than 30 wt. %, nor is it possible to attain desired adhesive force or reduce water resistance when its amount is more than 60 wt. %. Neither is thus preferred.

In the present invention, a monofunctional or polyfunctional polymerizable monomer as described below can be used in combination with the above-described essential components (A) and (B).

Examples of the monofunctional monomer include n-alkyl (meth)acrylates such as benzyl (meth)acrylate, nonyl (meth)acrylate, dodecyl (meth)acrylate, and lauryl (meth)acrylate, isoalkyl (meth)acrylates such as isobutyl (meth)acrylate, 2-ethylhexyl (meth)acrylate, 2-ethylhexylcarbitol (meth)acrylate, 2-hydroxyethyl (meth)acrylate, 2-hydroxypropyl (meth)acrylate, 2-hydroxybutyl (meth)acrylate, polyethylene glycol (meth)acrylate, polypropylene glycol (meth)acrylate, methoxypolyethylene glycol (meth)acrylate, methoxypolypropylene glycol (meth)acrylate, tetrahydrofurfuryl (meth)acrylate, 2-acryloyloxyethyl succinic acid, propyl (meth)acrylate, isopropyl (meth)acrylate, butyl (meth)acrylate, amyl (meth)acrylate, t-butyl (meth)acrylate, pentyl (meth)acrylate, isoamyl (meth)acrylate, hexyl (meth)acrylate, heptyl (meth)acrylate, octyl (meth)acrylate, isooctyl (meth)acrylate, isodecyl (meth)acrylate, undecyl (meth)acrylate, octadecyl (meth)acrylate, strearyl (meth)acrylate, butoxyethyl (meth)acrylate, ethoxydiethylene glycol (meth)acrylate, cyclohexyl acrylate, ethoxyethyl (meth)acrylate, methoxypolyethylene glycol (meth)acrylate, methoxypolypropylene glycol (meth)acrylate, bornyl (meth)acrylate, t-octyl (meth)acrylamide, dimethylaminoethyl (meth)acrylate, diethylaminoethyl (meth)acrylate, 7-amino-3,7-dimethyloctyl (meth)acrylate, and (meth)acrylate compounds represented by the below-described formula (3) or (4): 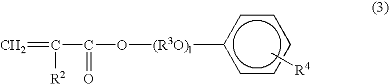
(wherein, R² represents a hydrogen atom or a methyl group, R³ represents an alkylene group having 2 to 6, preferably 2 to 4 carbon atoms, R⁴ represents an alkyl group having 1 to 12, preferably 1 to 9 carbon atoms, and 1 stands for 0 to 12, preferably 1 to 8) 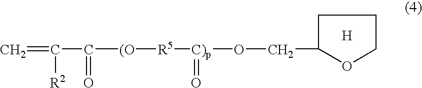
(wherein, R² has the same meaning as described above, R⁵ represents an alkylene group having 2 to 8, preferably 2 to 5 carbon atoms, and p stands for 1 to 8, preferably 1 to 4).

Examples of the commercially available product of the compound represented by the formula (3) or (4) include “AIB, 2-MTA, Viscoat #158, and #3700” (each, product of Osaka Organic Chemical Co., Ltd.), “L-A, PO-A, P-200A and HOA-MS” (each, product of KYOEISHA CHEMICAL Co., LTD), “ARONIX M111, M113, M114, M117 and M120” (each, product of Toagosei Limited), “KAYARAD TC110S, R629, and R644” (each, product of Nippon Kayaku Co., Ltd.), and “SARTOMER506” (product of SOMAR CORP.)

The monofunctional monomers preferably do not include acrylate compounds represented by the following formula (5): 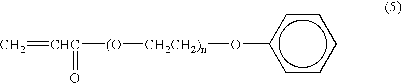
(wherein, n stands for an integer of from 1 to 5).

Examples of the polyfunctional monomer include trimethylolpropane tri(meth)acrylate, pentaerythritol tri(meth)acrylate, ethylene glycol di(meth)acrylate, polyethylene glycol di(metha)crylates such as tetraethylene glycol di(meth)acrylate, 1,4-butanediol di(meth)acrylate, 1,6-hexanediol di(meth)acrylate, neopentyl glycol di(meth)acrylate, trimethylolpropanetrioxyethyl (meth)acrylate, tris(2-hydroxyethyl)isocyanurate tri(meth)acrylate, tris(2-hydroxyethyl)isocyanurate di(meth)acrylate, tricyclodecanedimethanol di(meth)acrylate, and epoxy (meth)acrylate obtained by adding (meth)acrylate to digycidyl ether of bisphenol A. Their commercially available products include “YUPIMER-UV, SA1002, and SA2007” (each, product of Mitsubishi Chemical Corp.), “Viscoat 700” (product of Osaka Organic Chemical Industry Co., Ltd.), “KAYAPAD R-604, DPCA-20, 30, 60, 120, HX-620, D-310, and 330” (each, product of Nippon Kayaku Co., Ltd.), and “ARONIX M-210, 215, 315, and 325 (each, product of Toagosei Co., Ltd.).

In consideration of the adhesive force and the like, the monofunctional or polyfunctional polymerizable monomer other than the components (A) and (B) is preferably added in an amount of 0 to 70 wt. %, more preferably from 0 to 70 wt. % in the composition.

The liquid curing resin composition of the present invention is able to have improved adhesion to a substrate by incorporating a silane compound in the composition. No particular limitation is imposed on the silane compound, but γ-mercaptopropyltrimethoxysilane is preferred. The silane compound is preferably added in an amount of 0.1 to 5 wt. % to the composition.

The liquid curing resin composition of the present invention can be cured by radiation. The term “radiation” as used herein means active energy rays such as visible light, ultraviolet light, electron beams and X-rays. When the liquid curing resin composition of the present invention is cured by ultraviolet light, use of an ultraviolet light sensitive photopolymerization initiator is preferred. Examples of the ultraviolet light sensitive photopolymerization initiator include 1-hydroxycyclohexyl phenyl ketone, 2,2-dimethoxy-2-phenylacetophenone, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, Michler's ketone, benzoin propyl ether, benzoin ethyl ether, benzyl dimethyl ketal, 1-(4-isopropylphenyl)-2-hydroxy-2-methylpropan-1-one, 2-hydroxy-2-methyl-1-phenylpropan-1-one, thioxanthone, diethylthioxanthone, 2-isopropylthioxanthone, 2-chlorothioxanthone, 2-methyl-i-[4-(methylthio)phenyl]-2-morpholino-propan-1-one, and 2,4,6-trimethylbenzoyldiphenyl-phosphine oxide. Their commercially available products include “IRGACURE 184, 651, 500, 907, CG1369, and CG24-61 (each, product of Ciba Geigy), “Lucirine LR8728 (product of BASF), “Darocure 1116 and 1173” (each, product of Merck Co.), and “Uvecryl P36” (product of UCB Chemicals Corporation).

When the composition is cured by a visible light, use of a visible-light-sensitizing type photopolymerization initiator such as camphorquinone is preferred.

The sensitivity of photopolymerization can also be improved by the addition of an additive having a sensitizing action. Examples of the photosensitizer include triethylamine, diethylamine, N-methyldiethanolamine, ethanolamine, 4-dimethylaminobenzoic acid, methyl 4-dimethylaminobenzoate, ethyl 4-dimethylaminobenzoate, and isoamyl 4-dimethylaminobenzoate. Their commercially available products include “Uvecryl P102, 103, 104, and 105” (each, product of UCB Chemical Corporation). The above-described photopolymerization initiator is preferably added in an amount of from 0.1 to 10 wt. % to the composition.

The liquid curing resin composition of the present invention can be prepared by mixing the above-described components in a manner known per se in the art. The composition of the present invention thus prepared usually has a viscosity of from 100 to 20000 cps/25° C., preferably from 200 to 10000 cps/25° C.

Since the liquid curing resin composition of the present invention exhibits excellent adhesion, is superior in heat resistance and water resistance, and is excellent in moldability or formability, it is useful as a composition for adhesives. Particularly, it exhibits excellent adhesion to glass, plastic substrate, particularly to an MS plate or PET film so that it is suited for laminating an MS plate or PET film to a substrate such as PVC sheet. In addition, it is useful in a variety of fields such as building decorative materials, packaging materials, printing materials, display materials, materials for electrical and electronic components, materials for optical components, and liquid crystal panels.

### EXAMPLES

The present invention will hereinafter be described specifically by Examples. It should however be borne in mind that the present invention is not limited to or by these Examples. In the below described designations of “part” or “parts” indicates “part by weight” or “parts by weight”, respectively.

### Urethane Acrylate Synthesis Example 1

In a reaction vessel equipped with a stirrer, 696 g of tolylene diisocyanate, 12,000 g of polypropylene glycol having a number-average molecular weight of 4000, and 3.1 g of 2,6-di-t-butyl-p-cresol as a polymerization inhibitor were charged. After the reaction mixture was cooled to 15° C. in an ice-water bath, 10.3 g of dibutyltin dilaurate was added to initiate a reaction. While maintaining the temperature at 30 to 40° C., the reaction was effected for 2 hours. Then, 232 g of hydroxyethyl acrylate was added. After stirring was continued for 5 hours at a temperature of from 50 to 60° C., the reaction was terminated, whereby a urethane acrylate (A1) having a number-average molecular weight of 12928 was obtained.

### Urethane Acrylate Synthesis Example 2 and Comparative Synthesis Examples 1 to 3

In a similar manner to Synthesis Example 1 except that the amount of each component of Synthesis Example 1 was changed, urethane acrylates were prepared. The amount of each component and the molecular weight of the resulting urethane acrylates are shown in Table 1. The unit of the amount of each component in the table is gram.

TABLE 1

| | | | | Comparative | Comparative | Comparative |
|---|---|---|---|---|---|---|
| | | Synthesis | Synthesis | Synthesis | Synthesis | Synthesis |
| | | Example 1 | Example 2 | Example 1 | Example 2 | Example 3 |
| Tolylene diisocyanate | | 696 | 1,218 | 348 | 348 | 522 |
| Polypropylene glycol | | 12,000 | 24,000 | — | — | 8,000 |
| (Molecular weight: 4,000) | | | | | | |
| Polypropylene glycol | | — | — | 3,000 | — | — |
| (Molecular weight: 3,000) | | | | | | |
| Polypropylene glycol | | — | — | — | 2,000 | — |
| (Molecular weight: 2,000) | | | | | | |
| 2,6-Di-t-butyl-p-cresol | | 3.1 | 6.1 | 0.86 | 0.62 | 2..1 |
| Dibutyltin dilaurate | | 10.3 | 20.4 | 2.86 | 2.06 | 7.0 |
| Hydroxyethyl acrylate | | 232 | 232 | 232 | 232 | 232 |
| Urethane acrylate | Molecular | 12928 | 25450 | 3580 | 2580 | 8754 |
| | weight | | | | | |
| | Name | A1 | A2 | R¹ | R² | R³ |

### Examples 1 to 4, and Comparative Examples 1 to 5

In a reaction vessel equipped with a stirrer, the urethane acrylate oligomer prepared in accordance with the formulation in Table 1, a reactive diluent and a polymerization initiator were charged. The mixture was stirred at a temperature ranging from 50 to 60° C., whereby samples of Examples 1 to 4 and Comparative Examples 1 to 5 were prepared.

A test piece was formed as described below by using each of the liquid compositions and it was evaluated. The results are shown in Table 2.

1. Preparation of a Test Piece

Each liquid composition was applied to a PET film of 100 μm in thickness or an MS plate of 3 mm in thickness by using an applicator bar. Then, a clear PET film of 100 μm in thickness was stacked over the coated film or plate so as to prevent entry of air bubbles therebetween. The clear film side of the resulting laminate was exposed to ultraviolet light of 1.0 J/cm². After curing, the test piece was conditioned under 23° C. and relative humidity of 50% for 24 hours, and it was provided as a test piece for adhesion evaluation.

2. Measurement of Adhesive Force

The adhesive force of the test piece was measured in accordance with JISK6854 at a pulling rate of 50 mm/min by a tensile tester under the conditions of 23° C. or 100° C., and a relative humidity of 50%. The adhesive force between PET films was examined by the T peel test, while that between the PET film and MS plate was examined by the 180° peel test.

TABLE 2

| | Examples | | | | Comparative Examples | | | | |
|---|---|---|---|---|---|---|---|---|---|
| | 1 | 2 | 3 | 4 | 1 | 2 | 3 | 4 | 5 |
| (A) Urethane acrylate A1 | 50 | — | 50 | 50 | — | 50 | — | — | 50 |
| (A) Urethane acrylate A2 | — | 50 | — | — | — | — | — | — | — |
| Urethane acrylate R¹ | — | — | — | — | — | — | — | 30 | — |
| Urethane acrylate R² | — | — | — | — | 50 | — | — | — | — |
| Urethane acrylate R³ | — | — | — | — | — | — | 70 | — | — |
| (B) Acryloylmorpholine (ACMO) | 15 | 15 | — | 15 | 15 | — | 15 | 15 | 20 |
| (B) N-vinylcaprolactam (V-CAP) | 5 | 5 | — | 5 | 5 | — | — | 10 | — |
| (B) Isobomyl acrylate (IBXA) | 25 | 25 | 50 | 25 | 25 | — | 15 | 25 | — |
| Nonylphenol EO modified (n = 4) acrylate | 5 | 5 | — | 5 | 5 | 25 | — | — | 30 |
| (M113) | | | | | | | | | |
| Phenoxyethyl acrylate (PHE) | — | — | — | — | — | 25 | — | 20 | — |
| 1-Hydroxycyclohexylphenylketone | 3 | 3 | 3 | 3 | 3 | 3 | 3 | 3 | 3 |
| (Irg. 651) | | | | | | | | | |
| Irganox 1035 | 0.3 | 0.3 | 0.3 | 0.3 | 0.3 | 0.3 | 0.3 | 0.3 | 0.3 |
| y-Mercaptopropyltrimethoxysilane | 1 | 1 | 1 | — | 1 | 1 | 1 | 1 | 1 |
| (MERCA) | | | | | | | | | |
| PET/PET T peel adhesive force (N/m) | | | | | | | | | |
| 23° C. | 2000 | 2400 | 700 | 700 | 600 | 300 | 150 | 500 | 1000 |
| 100° C. | 120 | 80 | 170 | 90 | 5 | 30 | 10 | 20 | 80 |
| MS/PET 180° peel adhesive force (N/m) | | | | | | | | | |
| 23° C. | 5000 | 6000 | 4100 | 3600 | 2800 | 1500 | 300 | 2400 | 3000 |
| 100° C. | 350 | 210 | 400 | 210 | 7 | 100 | 30 | 50 | 170 |

As can be understood from Table 2, the compositions of Comparative Examples 1 to 4 free of the component (A) or (B) of the present invention exhibited insufficient adhesive force, while the compositions of the present invention exhibited strong adhesive force. Comparison between Examples 1 to 4 and Comparative Examples 1 to 4 has revealed that the adhesive force and heat resistance were insufficient when urethane (meth)acrylate had a number-average molecular weight less than 10000. The compositions of Examples 1, 2, 3 and 4 having the component (B) in an amount of from 30 to 60 wt. % exhibited superior adhesive force to MS/PET, compared with the composition of Comparative Example 5 having it in an amount of 20 wt. %. It has also been found that the composition has improved adhesive force and heat resistance when γ-mercaptopropyltrimethoxysilane is added.

1. A liquid curing resin composition comprising the following components (A) and (B):
(A) 30 to 70 wt. % of a urethane (meth)acrylate having a number-average molecular weight of from 10000 to 40000, and
(B) 30 to 60 wt. % of an ethylenically unsaturated monomer having a glass transition point, in the form of a homopolymer, of 60° C. or greater.

2. The liquid curing resin composition of claim 1, further comprising γ-mercaptopropyltrimethoxysilane.

3. The liquid curing resin composition of claim 1 or 2, wherein the component (B) contains at least one compound selected from the group consisting of acryloylmorpholine, dimethylacrylamide, N-vinylpyrrolidone and N-vinylcaprolactam.

4. The liquid curing resin composition of any one of claims 1 to 3, which is suited for use as an adhesive.
